(19) United States
(12) Patent Application Publication
(10) Pub. No.: US 2017/0228497 A1
(43) Pub. Date: Aug. 10, 2017

(54) SYSTEMS AND METHODS FOR IDENTIFYING AND FLAGGING SAMPLES OF CONCERN

(71) Applicant: KONINKLIJKE PHILIPS N.V., EINDHOVEN (NL)

(72) Inventors: Sitharthan Kamalakaran, Pelham, NY (US); Joseph N. Paulson, Boston, MA (US)

(21) Appl. No.: 15/514,839

(22) PCT Filed: Sep. 8, 2015
(86) PCT No.: PCT/IB2015/056858

§ 371 Date: Mar. 28, 2017

Related U.S. Application Data
(60) Provisional application No. 62/056,875, filed on Sep. 29, 2014.

(51) Int. Cl. G06F 19/22; G06F 19/24; G06N 7/00; G06F 19/14

(52) U.S. Cl. CPC G06F 19/22; G06F 19/14; G06F 19/24; G06N 7/005

(57) ABSTRACT

The present disclosure describes systems and methods for determining and flagging sequences that deviate from one or more reference sequences. Phylogenetic methods are used for determining the evolutionary history and evolutionary distances of sample isolates. The evolutionary distances of sample isolates may be compared to each other and/or reference isolates. Based on a comparison of the evolutionary distances, a determination of deviance is made for a sample sequence. The sample sequence is flagged for further analysis to determine the cause of deviation.

### BACKGROUND

Healthcare-associated infections (HAIs) are patient-acquired infections received during healthcare treatment for conditions unrelated to the infection. A healthy patient entering a hospital for a surgical procedure to repair a hernia who subsequently develops a staph infection at the surgical site while in the recovery ward is an example of a patient-acquired HAI. HAIs in the medical literature are often referred to as nosocomial infections. According to a survey conducted by the CDC in 2011, approximately 1 out of every 25 patients hospitalized will contract an HAI. The study estimated that there were approximately 721,000 HAIs. HAIs cause or contribute to approximately 75,000 deaths each year.

Nosocomial infections can cause severe pneumonia and infections of the urinary tract, bloodstream and other parts of the body. Many types are difficult to attack with antibiotics, and antibiotic resistance is spreading to Gram-negative bacteria that can infect people outside the hospital. In the USA, the most frequent type of infection hospital-wide is pneumonia (21.8%), followed by surgical site infection (21.8%), and gastrointestinal infection (17.1%). (Magill S S, Edwards J R, Bamberg W, et al. “Multistate Point-Prevalence Survey of Health CareAssociated Infections,” N Engl J Med 2014;370:1198-208.)

According to a 2009 report by the CDC, HAIs cost U.S. hospitals approximately $35 billion per year. Much of the cost is related to longer patient stays, quarantining parts of the hospital, and discovering and eradicating the source of infection. Approximately 25.6% of HAIs are believed to be caused by medical devices such as catheters and ventilators. The remaining infections are believed to be associated with surgical procedures and other sources within the hospital. (Scott II, R. D., “The Direct Medical Costs of Healthcare-Associated Infections in U.S. Hospitals and the Benefits of Prevention,” CDC, March 2009.)

As genetic sequencing technology becomes more widely available, it is becoming more feasible to collect samples from patients to sequence genetic information. This genetic information may be from infection causing pathogens, patient tissue, or other sources. Similarities found across large data sets may be used to draw conclusions about the nature of the organism from which the genetic information was derived. However, misclassification of sequences in the large data sets may skew results. Furthermore, due to the massive data contained in genetic sequences, medical staff can become overwhelmed by the information and be unable to act on it.

### SUMMARY OF THE INVENTION

According to an illustrative embodiment of the invention, a method may include accessing a sequence of a sample isolate in a memory accessible by at least one processing unit; comparing, with the at least one processing unit, the sequence of the sample isolate to at least one reference sequence of a reference isolate stored in a database accessible to the processor to determine variants between the sample isolate sequence and the at least one reference sequence; calculating an evolutionary distance between the sample isolate and the at least one reference sequence, based at least in part, on the variants; determining whether the sample isolate is deviant from the at least one reference sequence with the at least one processing unit based at least in part on the evolutionary distance; and storing the sequence of the sample isolate in the memory with a flag if the sample isolate is deviant, wherein the flag may indicate that the sequence of the sample isolate requires further analysis. The method may further include analyzing the flagged sequence of the sample isolate for contaminants. The sample isolate may be determined to be deviant from the at least one reference sequence if the evolutionary distance is above a desired threshold value.

According to an illustrative embodiment of the invention, a method may include comparing, with at least one processing unit, a sequence of a sample isolate stored in a memory accessible by the at least one processing unit to at least one reference sequence stored in a database accessible to the at least one processing unit to determine variants between the sample isolate sequence and the at least one reference sequence; determining, with the at least one processing unit, an evolutionary distance of the sample isolate from the at least one reference sequence, based at least in part, on the variants; calculating a probability that the sample isolate is deviant from the at least one reference isolate, based at least in part, on a difference of the evolutionary distance of the sample isolate and the distribution of evolutionary distances of the plurality of sequences; determining that the sample isolate is deviant from the at least one reference isolate may be responsive to the probability being above a desired threshold value; and flagging the sample isolate in memory, wherein flagging may indicate that the sequence of the sample isolate may require further analysis. The determination of whether the sample isolate is deviant may be based, at least in part, on whether the evolutionary distance of the infection isolate falls within a desired confidence interval of the distribution of evolutionary distances of the plurality of sequences.

According to an illustrative embodiment of the invention, a system may include a processing unit, a memory accessible to the processing unit, a database accessible to the processing unit, and a display coupled to the processing unit, wherein the processing unit may be configured to compare a sequence of a sample isolate stored in the memory to at least one reference sequence stored in the database to determine variants between the sample isolate sequence and the at least one reference sequence, calculate an evolutionary distance of the sample isolate, based at least in part, on the variants, compare the evolutionary distance of the sample isolate to an evolutionary distance of the at least one reference sequence, determine that the sample isolate sequence is deviant from the at least one reference sequence responsive to a difference of the evolutionary distance of the sample isolate and the evolutionary distance of the at least one reference sequence exceeding a desired threshold value, store the sample isolate sequence with a flag in the memory if determined to be deviant, wherein the flag may indicate that the sequence of the sample isolate may require further analysis. The system may further include a computer system accessible to the processing unit, wherein the processing unit may be configured to provide the determination of whether the sample isolate is deviant. The system may further include a sequencing unit that may be configured to provide the sequence of the sample isolate to the memory.

### BRIEF DESCRIPTION OF THE DRAWINGS

FIG. 1 is a flow chart of a method according to an embodiment of the disclosure.

FIG. 2 is a block diagram of a system according to an embodiment of the disclosure.

FIG. 3 is a flow chart of processes according to embodiments of the invention.

FIG. 4A is a phylogenetic tree according to an embodiment of the disclosure.

FIG. 4B is a phylogenetic tree according to an embodiment of the disclosure.

FIG. 4C is a phylogenetic tree according to an embodiment of the disclosure.

FIG. 4D is a phylogenetic tree according to an embodiment of the disclosure.

FIG. 5 is a density plot and heat map according to an embodiment of the disclosure.

FIG. 6 is an empirical cumulative distribution function plot according to an embodiment of the disclosure.

### DETAILED DESCRIPTION

The following description of certain exemplary embodiments is merely exemplary in nature and is in no way intended to limit the invention or its applications or uses. In the following detailed description of embodiments of the present systems and methods, reference is made to the accompanying drawings which form a part hereof, and in which are shown by way of illustration specific embodiments in which the described systems and methods may be practiced. These embodiments are described in sufficient detail to enable those skilled in the art to practice the presently disclosed systems and methods, and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of certain features will not be discussed when they would be apparent to those with skill in the art so as not to obscure the description of the present system.

Medical facilities may analyze genetic information such as genetic sequences for a variety of applications. An example application of analyzing genetic sequences is infection control. An infection may be caused by a pathogen such as bacteria, a virus, a fungus, a parasite, or other organism. Some infections may be caused by multiple types of organisms present at the same time. In some instances, an infection may be transmitted between two living organisms. In other instances, an infection may be transmitted to a living organism from a non-living specimen.

Hospitals and other health care facilities often have a baseline level of HAIs. Despite stringent infection control protocols, pathogens may still be present in the facility. Infection control staff may monitor the baseline level HAIs to watch for signs of outbreaks and/or changes in virulence of HAIs. An outbreak is when a large number of patients acquire HAIs in a short period of time. An outbreak may be caused by a new source of infection or a change in virulence of a previously present pathogen. When an outbreak occurs, infection control staff may attempt determine whether the HAIs are from a single source and whether the source or sources are inside or outside the facility. This may allow them to determine how to reduce new patients from acquiring an HAI.

When an outbreak is suspected, samples may be collected by medical staff from patients, surfaces, food, equipment, or other suspected sources. Medical staff may also collect samples on a routine basis as part of regular HAI monitoring. Samples may include tissue, blood, water, and swabs of surfaces. The samples may then be processed to isolate the pathogen causing the infection from other materials in the sample. The infection isolate and/or other isolate of interest may then be analyzed by a variety of methods. The analysis may determine the pathogen type, species, drug resistance, and/or other properties. If a large number of samples are collected, the infection control staff may have difficulty finding patterns or analysis error in the collected data. Overlooking patterns or using erroneous data may cause the infection staff to draw improper conclusions about the source of an HAI.

For example, an outbreak of staph infections may occur in a burn ward of a hospital. The medical staff collects samples from the patients for analysis. If one patient's sample was contaminated by a non-sterile sample receptacle, that patient may be misclassified as having an infection contracted by a different source than the rest of the patients. The infection control staff may waste time and resources searching erroneously for a second infection source. In another example, one patient may have a more virulent strain of staph infection, even though the patient was infected by the same source. The change in virulence may be caused by a genetic mutation in the infection. This change in virulence may be overlooked or the patient may be misclassified as above as having an infection from a different source than the rest of the patients.

By collecting an infection isolate from a sample and analyzing its genetic sequence, it may be possible to determine a source of infection, virulence of the infection, and species of the pathogen causing the infection by using phylogenetic methods. An isolate is a component of the sample that includes genetic information from an organism of interest. In addition to infection sourcing, phylogenetic methods may also be used to find samples that may be contaminated or were incorrectly identified by a previous analysis. Phylogenetics is the study of evolutionary relationships between organisms. Phylogenetic methods analyze all or a portion of a genetic sequence of an organism. By determining an evolutionary history of an infection, it may be possible to provide an understanding of how different incidents of an infection are or are not related. For example, the sequences of infection isolates from multiple infected patients may be compared. It may be possible to determine that one or more of the patients are infected by a different strain of bacteria or if one or more patients have a more virulent strain of the bacteria.

Multiple phylogenetic methods exist, including methods based on evolutionary distances, parsimonious, and maximum likelihoods. Distances based methods are where an evolutionary distance is calculated between each organism. The evolutionary distance is calculated based on the degree of similarity between genetic sequences of organisms. Differences between the two sequences are often referred to as variants. The fewer variants between sequences, the smaller the evolutionary distance between the organisms. One such method for determining evolutionary distances is called the Jukes-Cantor (Evolution of protein molecules In Mammalian protein metabolism, Vol. III (1969), pp. 21-132 by T. H. Jukes, C. R. Cantor edited by M. N. Munro) method where the transition from any particular letter in the genome to another occurs with the same probability:

$$Q = [ \begin{matrix}- \frac{3 μ}{4} & \frac{μ}{4} & \frac{μ}{4} & \frac{μ}{4} \\ \frac{μ}{4} & - \frac{3 μ}{4} & \frac{μ}{4} & \frac{μ}{4} \\ \frac{μ}{4} & \frac{μ}{4} & - \frac{3 μ}{4} & \frac{μ}{4} \\ \frac{μ}{4} & \frac{μ}{4} & \frac{μ}{4} & - \frac{3 μ}{4}\end{matrix} ] \qquad Equation 1$$

In Equation 1, above, the instantaneous rate matrix Q represents the rates of change between a pair of nucleotides per instant of time. P—the probability transition matrix is given as

p(t)=e^{Qt} Equation 2

As a result, the evolutionary distance between any two organisms under this model is simply:

d_{ab}=−3/4In. (1−4/3p) Equation 3

Where p is the number of sites along the single nucleotide polymorphisms (SNPs)/DNA that differ between the sequences. The distance goes to infinity as p approaches the equilibrium value (75% of sites differ). This simple model, however does not take into account the biological consideration that transitions (purine to purine (a-g) or pyrimidine to pyrimidine (t-c)) and transversions (purine to pyrimidine or vice-versa) occur at different rates. Another distance model, the Kimura 2-parameter model (Kimura, Motoo. “A simple method for estimating evolutionary rates of base substitutions through comparative studies of nucleotide sequences.” Journal of molecular evolution 16.2 (1980): 111-120), attempts to correct for this. In this case:

d==−1/2In [(1−2p−q) (sqrt(1−2q))] Equation 4

For p (proportion of transitions) and q (proportion of transversions).

Once sample isolate sequences have been compared to determine their evolutionary distances, rates of evolution may be determined. The evolutionary distances and relationships between isolates from samples may then be plotted in graphical form, such as a tree plot. Neighbor Joining (Saitou N, Nei M. “The neighbor-joining method: a new method for reconstructing phylogenetic trees.” Molecular Biology and Evolution, volume 4, issue 4, pp. 406-425, July 1987) is one method of building unrooted trees. The method corrects for unequal evolutionary rates between sequences by first finding a pair of neighboring leaves i and j which have the same parent node k. That is, leaves i and j may be organisms that evolved from a common organism k. Leaves i and j may then be removed from the list of leaf nodes and k is added to the current list of nodes, and node distances are recalculated. This algorithm is an example of a greedy “minimum evolution” algorithm.

Another method of building phylogenetic trees is the unweighted pair group method with arithmetic mean (UPGMA) (Sokal R., Michener C. “A statistical method for evaluating systematic relationships.” University of Kansas Science Bulletin 38: 1409-1438, 1958). The UPGMA algorithm is agglomerative and generates a rooted tree. Initially, each sequence defines a single cluster. With each iteration, clusters are combined to form larger clusters. This continues until all sequences are included in a single cluster. With each iteration, two clusters of sequences that are found to have the shortest evolutionary distance are combined into a higher-level cluster. The evolutionary distance between clusters is the average of all evolutionary distances between corresponding pairs of sequences in each of the clusters. The algorithm reiterates until all sequences are placed in the tree.

Single-linkage clustering is a method of building rooted trees similar to UPGMA. However, rather than using the average evolutionary distance between all corresponding pairs of sequences between clusters, the evolutionary distance between clusters is defined by the minimum distance between a sequence in a first cluster and a sequence in a second cluster. That is, the distance of a single pair of sequences defines the distance between clusters.

Complete-linkage clustering is also a method of building rooted trees similar to UPGMA and single-linkage clustering. As with single-linkage clustering, the evolutionary distance between a single pair of sequences, each included in a different cluster, defines the evolutionary distance between two clusters. However, in complete-linkage clustering, the pair of sequences that has the greatest evolutionary distance defines the evolutionary distance between the two clusters.

Unlike neighbor joining, the UPGMA algorithm and related clustering algorithms assume a constant rate of evolution. The above methods of generating phylogenetic trees are provided for example purposes only. Other methods of generating phylogenetic trees may be used without departing from the scope of the invention.

Using the tree representation of many organism isolate sequence samples, it may be possible to estimate relative timing of one organism to another organism. Without loss of generality, a method called Mean Path Lengths (MPL) may be used (Britton, Tom, et al. “Phylogenetic dating with confidence intervals using mean path lengths.” Molecular phylogenetics and evolution 24.1 (2002): 58-65). The MPL method estimates the age of a node with the mean of the distances from this node to all leaves descending from it. Under the assumption of a similar molecular clock, that is, a rate of evolution, standard-errors of the estimated node ages can be computed. Using this method, mutation rates may be calculated for the different sample isolates.

It may be possible to determine one or more organisms originated from the same source based on the evolutionary distance and/or mutation rate. Different sources that have reservoirs of pathogens or other organisms may include but are not limited to blood, saliva, food, surgical tables, sinks, toilets, and bed linens. Genetic isolates from samples that are found to have similar evolutionary distances and/or rates of mutation compared to a reference isolate may have all originated from the reference isolate. Sample isolates whose sequences deviate more than what should be expected from a reference isolate sequence or sequences, based on one or more phylogenetic models may be from a different source, a more virulent strain, misclassified as a particular species/subspecies, and/or contaminated. Deviant sample isolate sequences may need further analysis by technical staff or infection control staff to determine the cause of deviation.

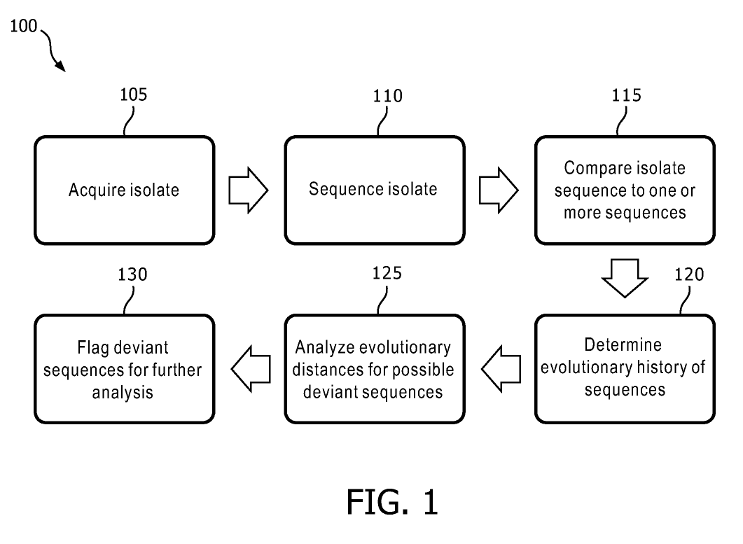

FIG. 1 illustrates a flow chart of a method 100 of determining deviant sequences and flagging them according to an embodiment of the disclosure. Medical staff may first collect samples from different environments to acquire a sample isolate or multiple sample isolates at Step 105. Samples may be collected routinely or may be collected in response to an identified HAI. The isolate may be processed and sequenced according to a sequencing technology known in the art at Step 110. Examples of companies that provide sequencing technology include 454 Life Sciences, a Roche company and Pacific Biosciences. Sequencing techniques known in the art may allow the entire genome of an isolate to be sequenced. A hospital may have sequencing technology on site or the hospital may send the samples to a separate sequencing company. A digital representation of the sequence may be generated and stored in a memory accessible to one or more processing units to allow analysis of the sequence. Unless otherwise noted, it will be assumed that any comparison, analysis, or determination based on a genetic sequence is performed by one or more processing units.

The isolate sequence may then be compared to one or more sequences at Step 115 by the processing unit. The other sequences may be from other collected isolates, reference sequences of known organisms from public or private databases, and/or sequences from other sources. The comparison may include determining variants between the isolate sequence and the one or more other sequences. Variants may be found using existing software tools such as BWA-samstools and Golden Helix. These variants may be used at Step 120 to determine the evolutionary history of the isolate sequence in relation to the one or more sequences. The evolutionary history may be determined by one of the methods described above or another method. Based on the evolutionary history, the isolate sequence may be analyzed at Step 125 to determine if it is deviant from the one or more sequences. Deviation may be based on an analysis of evolutionary distances and/or mutation rates of the sequences. For example, the greater the evolutionary distance, the more likely the isolate sequence may be considered deviant. A thresholding technique based on the evolutionary distance may be used for making a determination of deviance. Other methods of determining deviant sequences or other categorization of sample isolate sequences may be possible. Any deviant sequences may be flagged in the memory for further analysis at Step 130.

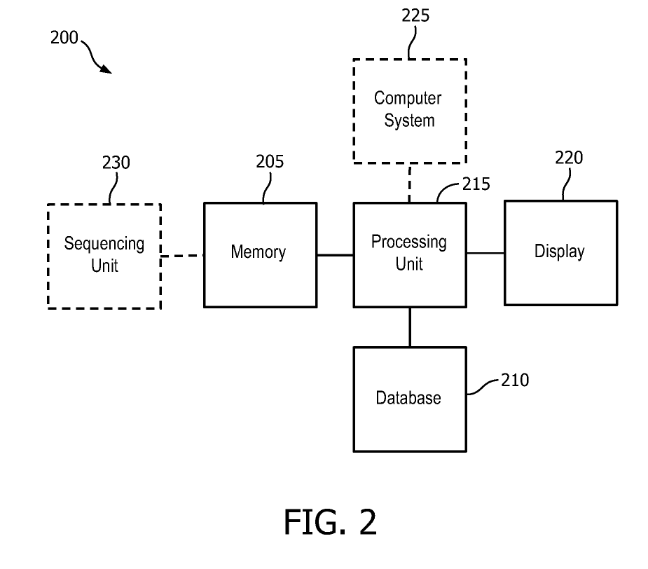

An example of a system 200 used for determining and flagging deviant sequences according to an embodiment of the disclosure is shown as a block diagram in FIG. 2. The isolate sequence in digital form may be included in memory 205. The memory 205 may be accessible to processing unit 215. The processing unit 215 may include one or more processing units. The processing unit 415 may have access to a database 210 that includes one or more sequences. The processing unit 215 may provide the results of its determination. For example, the results may be provided to a display 220 and/or the database 210. The display 220 may be an electronic display visible to a user. In some embodiments, the system may also include other examples of devices to provide the results, such as a printer. Optionally, processing unit 215 may further access a computer system 225. The computer system 225 may include additional databases, memories, and/or processing units. The computer system 225 may be a part of system 200 or remotely accessed by system 200. In some embodiments, the system 200 may also include a sequencing unit 230. The sequencing unit 230 may process the isolate to generate a sequence and produce the digital form of the isolate sequence.

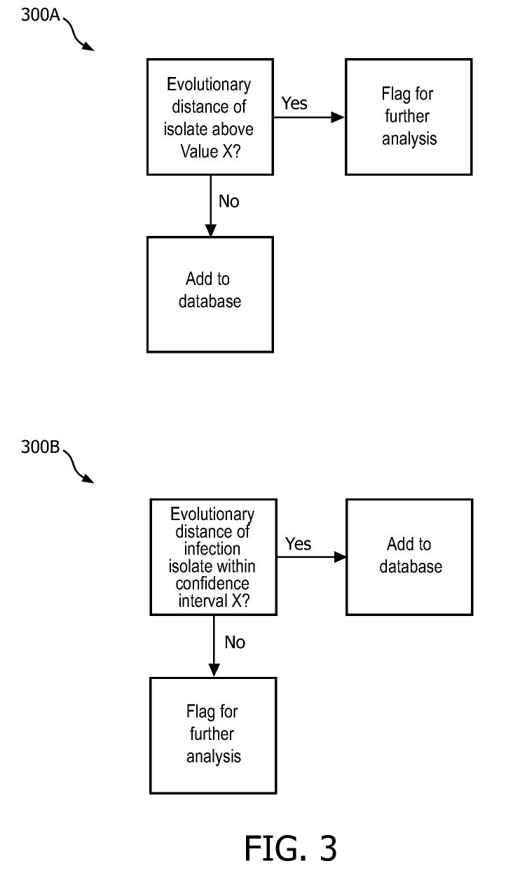

FIG. 3 illustrates a flow chart that summarizes example processes 300A and 300B according to embodiments of the disclosure of determining and flagging deviant sequences. The processes 300A and/or 300B may be included in Step 125 of method 100 in FIG. 1. Step 125 of method 100 may include one or more processes for determining if a sample isolate sequence is deviant. Process 300A determines whether the sample sequence is deviant from one or more sequences based on whether the evolutionary distance of the sample isolate is greater or less than a desired threshold Value X. Process 300B determines whether the sample sequence is deviant from one or more sequences based on whether the evolutionary distance of the sample isolate falls within a confidence interval X. The confidence interval may be based on a distribution of one or more sample sequences. Example processes will be explained in further detail below. Other processes may also be possible. A sequence may be determined to be deviant by one or more processes. Although a non-deviant sample sequence is shown being added to a database, such as database 210 in FIG. 2, the system may perform another action on the non-deviant sample. For example, non-deviant samples may be left in memory, such as memory 205. Alternatively, or in addition to, non-deviant samples may be provided to a remote computer system, such as computer system 225. This may allow sharing of information and/or increased reference databases in other facilities.

Once a sample isolate sequence is flagged as deviant by one or more of the methods described below, one or more actions may be taken by the system 200. The system may provide a visual indicator to a user on the display 220 to alert the user of the deviant sequences. The deviant sequences may be kept in memory 205, stored in a portion of the database 210 separate from reference and non-deviant sequences, and/or transmitted to the remote computer system 225. The one or more processing units 215 may automatically conduct further analysis on deviant sequences or a user may initiate further analysis. The analysis may be executed by the one or more processing units 215 or by a separate system, such as computer system 225. For example, the one or more processing units 215 and/or computer system 225 may run an analysis configured to detect contamination. Alternatively or in addition to, the one or more processing units 215 and/or computer system 225 may run an analysis configured to detect characteristics in the deviant sequence that are associated with increased virulence and/or drug resistance. The results of these additional analyses may then be provided to a user and/or stored in a database, such as database 210.

The user may use the flagged deviant sequences to determine which samples need to be re-sequenced and/or that new samples need to be collected. New samples may be acquired from sources whose sample isolates were flagged as deviant. The user may run the above processes on the deviant sequences against a different database of reference sequences to determine if the sequences were misclassified as another organism. In infection control, deviant sequences may be determined to have been acquired outside the hospital rather than classified as a HAI.

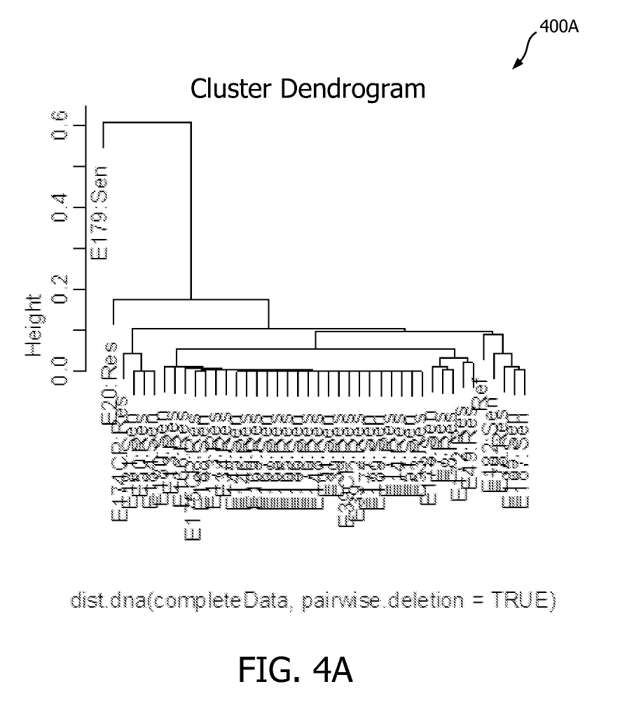

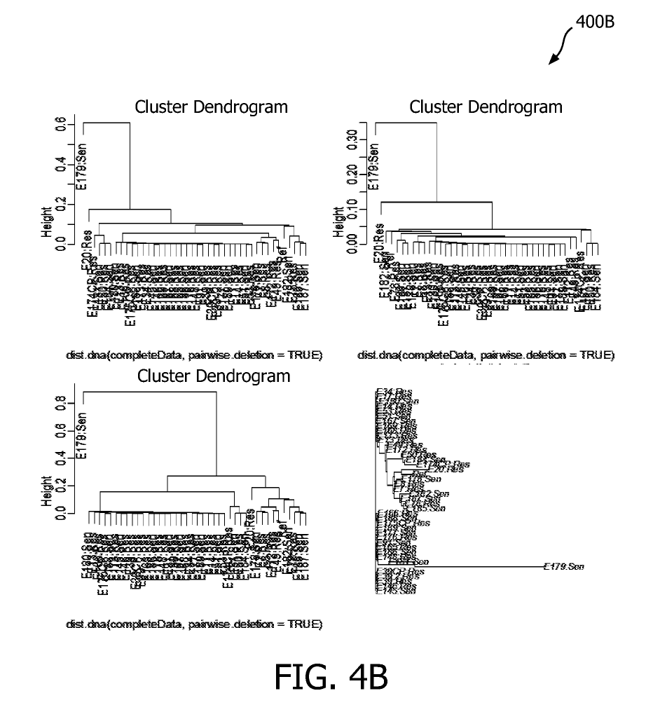

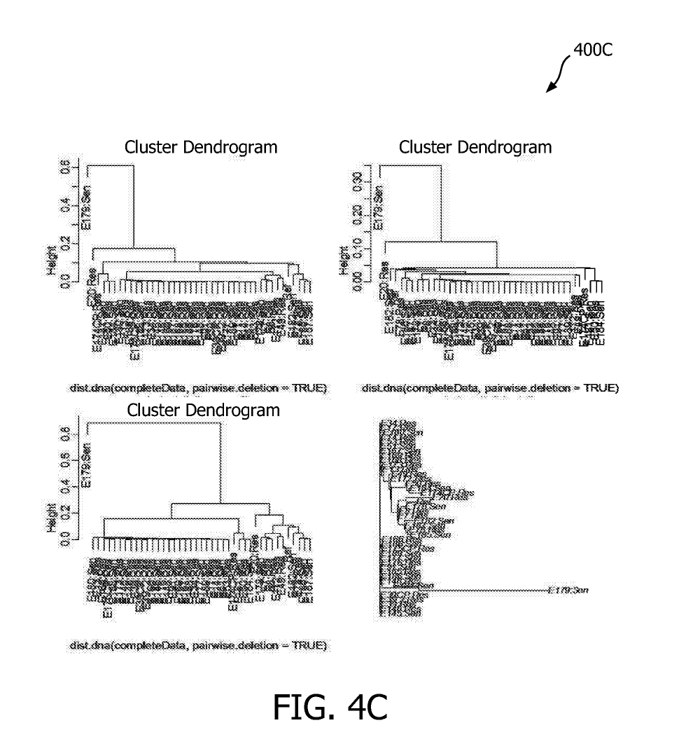

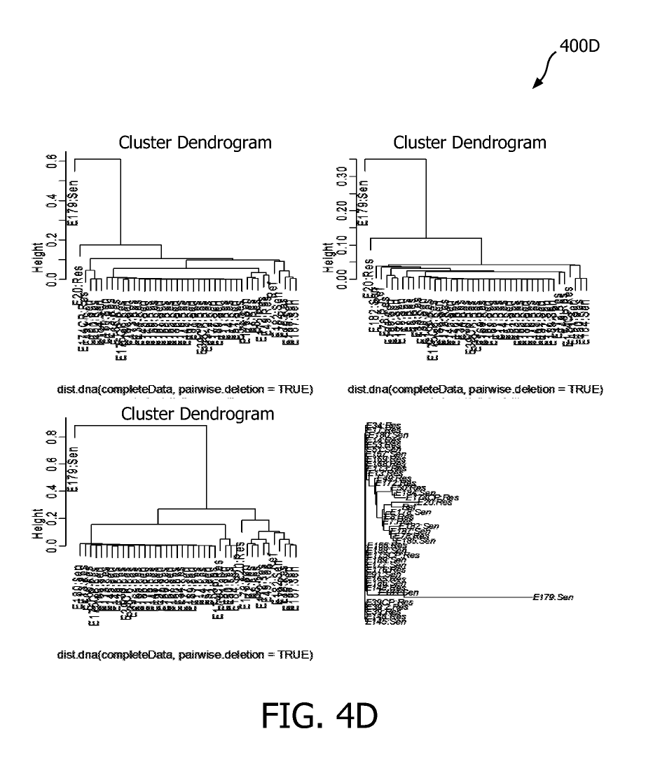

FIGS. 4A-D illustrate examples of determining and flagging sequences based on evolutionary distances according to an embodiment of the disclosure. In this example, infection isolate sequences from 42 samples collected at a local hospital are analyzed. The infection isolates may be from a human acquired infection. The entire genome of each infection isolate may be sequenced. Variants may be determined and evolutionary distances may be calculated. The samples may be clustered into a neighbor-joining tree or cluster using a variety of methods.

FIG. 4A illustrates a tree 400A generated using the UPGMA algorithm. FIG. 4B illustrates a tree 400B generated using the single-linkage method. FIG. 4C illustrates a tree 400C generated using the neighbor-joining method. FIG. 4D illustrates a tree 400D generated using the complete-linkage method. Each of the four methods determine Sample E179 has a significant evolutionary distance from the remaining samples. A threshold value for evolutionary distance may be defined. In this example, Sample E179 may exceed the evolutionary distance threshold value, and the system may determine Sample E179 is deviant and flag Sample E179 as requiring further investigation.

Alternatively, or in addition to, the relative evolutionary distance trees 400A-D may be converted into dated phylogenetic trees if a time point of one or more of the sequences is known. The MPL method described above or another method may be used. The dated tree may then be used to calculate mutation rates for each strain.

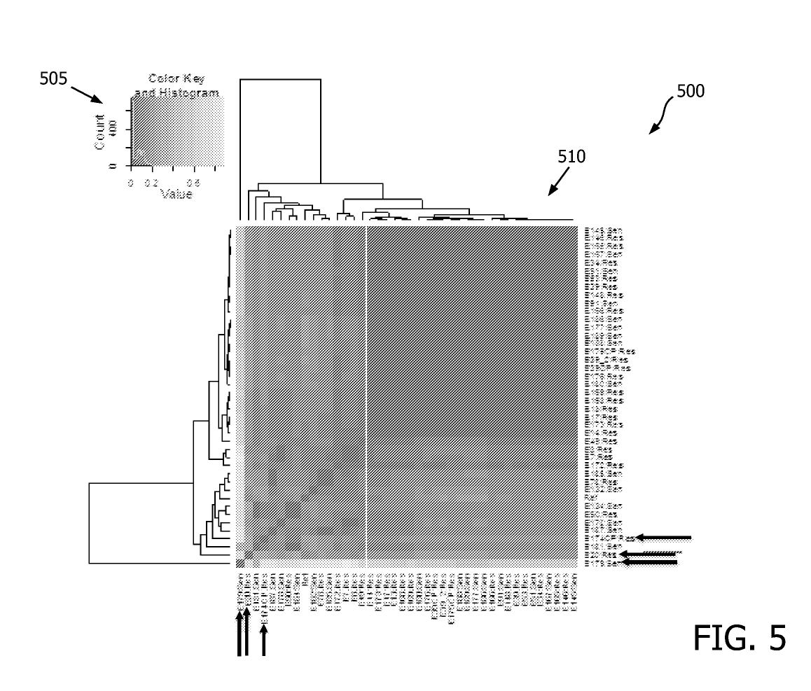

FIG. 5 illustrates a method according to an embodiment of the disclosure of determining and flagging sequences based on evolutionary distances. In this example, the 42 sample sequences are compared to reference sequences contained in a database. The database may include a plurality of reference sequences. In some embodiments, the database may include several thousands of reference sequences. The plot 500 includes a density plot 505. The data used to generate the density plot 505 may be used to form a probability distribution of evolutionary distances. A desired confidence interval may be set. If a sample isolate sequence falls outside a desired confidence interval of evolutionary distances of the reference sequences, the sample isolate sequence is determined to be deviant and is flagged. In the density plot 505, a sample isolate with an evolutionary distance of ˜0.138 has a probability of less than 0.05 of occurring within the distribution. If a 95% confidence interval is desired, in this example, Samples E179, E20, and E174 would be flagged. The use of probability distributions of evolutionary distances may allow the detection of sample sequences that deviate from the reference sequences only a small amount in numerical evolutionary distance, but have deviated significantly relative to the distribution of reference sequences. These samples may be overlooked using only absolute measures of differences in evolutionary distances. Density plot 505 also contains a color key. The most common evolutionary distances are assigned a different color or shade of pixels than less common evolutionary distances. The 42 sample sequences are then plotted in heat map 510. In this example, Sample E179 stands out visually from the other samples due to the lighter pixels, which correspond to a larger evolutionary distance. Although the heat map 510 may provide desirable visual information to a user, it may be optional.

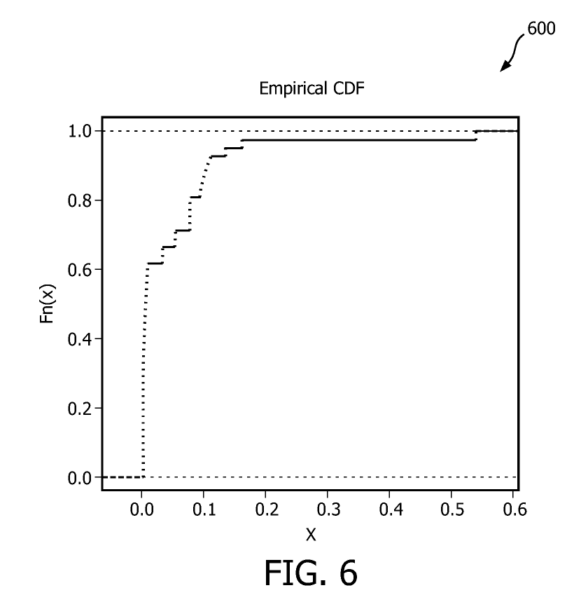

FIG. 6 illustrates a plot generated by a similar method to that used to generate plot 500 in FIG. 5. As above, the evolutionary distances of samples may be compared to the evolutionary distance distribution of known reference sequences or previously analyzed sample sequences. An empirical cumulative distribution function (ECDF) may then be generated using known statistical methods. An example ECDF plot 600 according to an embodiment of the disclosure is shown in FIG. 6. In this example, if an isolate sequence was determined to fall outside a desired confidence interval (e.g., 95%), the isolate sequence may be determined to be deviant from the reference sequences. In the plot shown in FIG. 6, it may be determined that any infection isolate sequence having x>0.138 is a deviant sequence and should be flagged for further analysis.

Although reference sequences are grouped into a single distribution in the examples shown in FIGS. 5 and 6, it may be possible to have multiple distributions of reference sequences. For example, each distribution may represent evolutionary distances for known subspecies of an organism. The confidence interval for a new sample isolate belonging to each distribution may then be calculated using known statistical methods. The sample isolate may then be determined to be deviant or not, based on whether the sample isolate sequence has a high probability of inclusion in one or more distribution.

Although many of the above examples are given in reference to HAI's and infection control in hospitals, other applications of determining and flagging deviant sequences may be possible. The examples given are for illustrative purposes only to assist in understanding the principles of the disclosure, and should not be considered to be limiting the scope of the invention.

Of course, it is to be appreciated that any one of the above embodiments or processes may be combined with one or more other embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1-6. (canceled)

7. A method, comprising:
comparing, with at least one processing unit, a sequence of a sample isolate stored in a memory accessible by the at least one processing unit to a plurality of reference sequences stored in a database accessible to the at least one processing unit to determine variants between the sample isolate sequence and the at least one reference sequence;
determining, with the at least one processing unit, an evolutionary distance of the sample isolate from the at least one reference sequence, based at least in part, on the variants;
calculating a probability that the sample isolate is deviant from the at least one reference sequence, based at least in part, on a difference of the evolutionary distance of the sample isolate and the distribution of evolutionary distances of the plurality of reference sequences;
determining that the sample isolate is deviant from the at least one reference sequence responsive to the probability being above a desired threshold value; and
flagging the sample isolate in memory, wherein flagging indicates that the sequence of the sample isolate requires further analysis.

8. The method of claim 7, wherein the determination of whether the sample isolate is deviant is based, at least in part, on whether the evolutionary distance of the infection isolate falls within a desired confidence interval of the distribution of evolutionary distances of the plurality of reference sequences.

9. The method of claim 8, wherein the confidence interval is 95%.

10. The method of claim 7, wherein the probability that the sample isolate is deviant from the at least one reference sequence increases as the evolutionary distance increases.

11. The method of claim 7, wherein calculating the probability that the sample isolate is deviant from the at least one reference sequence comprises determining a mutation rate of the sample isolate, based at least in part on the evolutionary distance, and comparing the mutation rate to a mutation rate of the at least one reference sequence, wherein the probability increases as a difference in mutation rates increases.

12. The method of claim 7, wherein the distribution of evolutionary distances of the plurality of reference sequences is a plurality of distributions based on evolutionary distances of the plurality of reference sequences.

13. The method of claim 12, wherein a first one of the plurality of distributions based on evolutionary distances of the plurality of reference sequences corresponds to a first species, and a second one of the plurality of distributions based on evolutionary distances of the plurality of reference sequences corresponds to a second species.

14. The method of claim 13, wherein the determination whether the sample isolate is deviant from at least one of the first or second one of the plurality of distributions is based, at least in part, on a probability of whether the evolutionary distance of the infection isolate is included in the first one or the second one of the plurality of distributions based on evolutionary distances of the plurality of reference sequences.

15. The method of claim 7, further comprising storing the sample isolate sequence in the database as one of the plurality of reference sequences, if the sample isolate is determined to not be deviant, for use in a future determination of whether a new sample isolate is deviant.

16. A system, comprising:
a processing unit;
a memory accessible to the processing unit;
a database accessible to the processing unit; and
a display coupled to the processing unit;
wherein the processing unit is configured to:
compare a sequence of a sample isolate stored in the memory to at least one reference sequence stored in the database to determine variants between the sample isolate sequence and the at least one reference sequence;
determine an evolutionary distance of the sample isolate from the at least one reference sequence, based at least in part, on the variants;
calculate a probability that the sample isolate is deviant from the at least one reference sequence based at least in part, on a difference of the evolutionary distance of the sample isolate and the distribution of evolutionary distances of the at least one reference sequence,
determine that the sample isolate is deviant from the at least one reference set responsive to the probability being above a desired threshold value and;
store the sample isolate sequence with a flag in the memory if determined to be deviant, wherein the flag indicates that the sequence of the sample isolate requires further analysis.

17. The system of claim 16, further comprising a computer system accessible to the processing unit, wherein the processing unit is configured to provide the determination of whether the sample isolate is deviant.

18. (canceled)

19. The system of claim 16, wherein the processing unit is configured to provide a visual indication on the display of the determination of whether the sample isolate is deviant.

20. The system of claim 16, wherein the processing unit is configured to analyze the sample isolate for contamination if the sample isolate is determined to be deviant.

21. The method of claim 7, further comprising analyzing the flagged sequence of the sample isolate for contaminants.

22. The method of claim 7, further comprising tagging the sequence of the sample isolate as a hospital acquired infection in the memory if the probability is below the desired threshold value.
